(19) United States
(12) Patent Application Publication
(10) Pub. No.: US 2010/0325373 A1
(43) Pub. Date: Dec. 23, 2010

(54) Duplexing Apparatus and Duplexing Control Method

(76) Inventors: Kazunari Kawamura, Akishima-shi (JP); Atsushi Watanabe, Koshigaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/782,531

(22) Filed: May 18, 2010

(30) Foreign Application Priority Data
Jun. 19, 2009 (JP) 2009-146798

(51) Int. Cl. G06F 12/00

(52) U.S. Cl. 711/154; 711/E12.001

(57) ABSTRACT

According to one embodiment, a duplexing apparatus includes a controller configured to write data in first storage module when the data is transferred from a host computer, to read the data from the first storage module when the notice has been transmitted to the host computer, the notice showing that the data is written in the first storage module and a second storage module, and to write the data read from the first storage module in the second storage module, and a transmission module configured to transmit the notice to the host computer when the data is written in the first storage module.

### CROSS-REFERENCE TO RELATED APPLICATIONS

This application is based upon and claims the benefit of priority from Japanese Patent Application No. 2009-146798, filed Jun. 19, 2009; the entire contents of which are incorporated herein by reference.

### FIELD

Embodiments described herein relate generally to a duplexing apparatus to control a duplexed storage unit, and a duplexing control method applied to the processor.

### BACKGROUND

A computer is used for executing various operations in many systems. If a failure occurs in such a system and a system goes down, the influence is serious. Therefore, various measures are taken to increase the reliability of a system.

Jpn. Pat. Appln. KOKAI Publication No. 2008-123481 discloses a technique, in which a storage medium (flash drive) provided in a computer system is mirrored, and the redundancy of data stored in the storage medium is improved, thereby increasing the reliability.

However, in the technique disclosed in the above Publication No. 2008-123481, mirroring is performed, and writing is completed after data is written to two storage media. This requires much load and time for writing data, compared with writing data to one storage medium. This problem is conspicuous in a flash memory having a slow writing speed.

### BRIEF DESCRIPTION OF THE DRAWINGS

FIG. 1 is an exemplary block diagram showing a host computer and a duplexing apparatus according to an embodiment of the invention;

FIG. 2 is an exemplary diagram showing a procedure to be executed between the host computer and duplexing apparatus of the embodiment;

FIG. 3 is an exemplary diagram showing an example of difference information stored in a difference information storage area used in the duplexing apparatus of the embodiment;

FIG. 4 is an exemplary flowchart showing an example of a procedure of duplexing control executed by the duplexing apparatus of the embodiment;

FIG. 5 is an exemplary flowchart showing an example of a procedure of duplexing control executed by the duplexing apparatus of the embodiment;

FIG. 6 is an exemplary diagram showing an example of difference information stored in a difference information storage area used in the duplexing apparatus of the embodiment; and

FIG. 7 is an exemplary diagram showing an example of difference information stored in a difference information storage area used in the duplexing apparatus of the embodiment.

### DETAILED DESCRIPTION

In general, according to one embodiment, a duplexing apparatus includes a controller configured to write data in a first storage module when the data is transferred from a host computer, to read the data from the first storage module when the notice has been transmitted to the host computer, the notice showing that the data is written in the first storage module and a second storage module, and to write the data read from the first storage module in the second storage module, and a transmission module configured to transmit the notice to the host computer when the data is written in the first storage module.

An embodiment of the invention will be explained hereinafter with reference to the accompanying drawings.

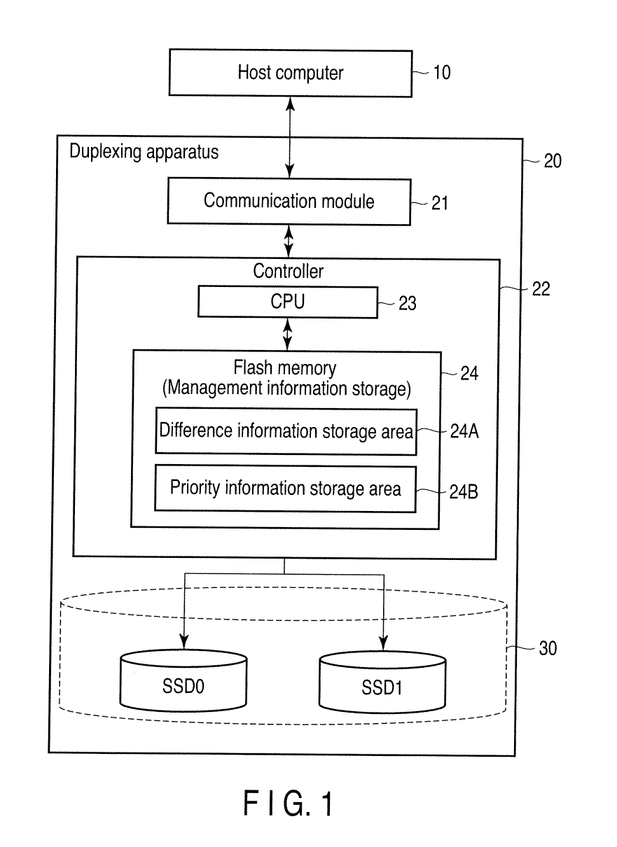

FIG. 1 shows a configuration of a duplexing apparatus according to an embodiment of the invention. A duplexing apparatus 20 is connected to a host computer 10, for example, and is realized as a duplexing apparatus (information processor) in which is with storage media such as a solid-state drive (SSD) and a hard disk drive (HDD). The duplexing apparatus 20 has a duplexing function. A duplexing function duplexes data by writing the same data to storage media incorporated in the duplexing apparatus 20, thereby increasing the redundancy. When data is transferred from the host computer 10, the duplexing apparatus 20 writes the data to one of the storage media, sends a notice of write completion to the host computer 10 before duplexing is finished, and performs duplexing in response to an actual write request. Therefore, the data can be duplexed at high speed without delaying the operation of the host computer 10 until the duplexing is completed (until the end of data writing to all storage media to be duplexed).

As described above, the duplexing apparatus 20 is connectable to the host computer 10, and has a function of duplexing and storing various data transferred from the host computer 10. The duplexing apparatus 20 comprises a communication module 21, a controller 22, and duplexing data storage 30. The communication module 21 transfers and receives data with the host computer 10. The controller 22 controls writing and reading of the data transferred from the host computer 10. The controller 22 comprises a CPU 23 that is a core of the controller 22, and a flash memory (a management information storage area) 24. The flash memory 24 comprises a difference information storage area 24A, and a priority information storage area 24B. The duplexing data storage 30 comprises a SSD0 (first storage module), and a SSD1 (second storage module). The storage information stored in the flash memory (management information storage area) 24 includes difference information compared with the other SSD, to which data is not written, when data is written to one of SSD0 and SSD1, and priority information in data storing in storage media in the duplexing apparatus 20. The data difference information is stored in the difference information storage area 24A, and the priority information is stored in the priority information storage area 24B.

FIG. 2 diagrammatically shows an operating procedure of the controller 22 for storing data transferred from the host computer 10 in duplexed form in the duplexing data storage 30.

First, the host computer 10 transfers data to the controller 22 of the duplexing apparatus 20. The controller 22 of the duplexing apparatus 20 writes the data transferred from the host computer 10 to SSD0 of the duplexing data storage according to predetermined priority information. After storing the data transferred from the host computer 10 to SSD0 of the duplexing data storage 30, the controller 22 sends a notice of write completion to the host computer 10. Actually, as described above, only the operation of storing the data transferred from the host computer 10 to SSD0 of the duplexing data storage 30 is completed, and the operation of storing the data in SSD1 of the duplexing data storage 30 is not completed. After sending the notice of write completion to the host computer 10, the controller 22 reads the data stored in SSD0 of the duplexing data storage 30, and stores the data in SSD1 of the duplexing data storage 30. After the notice of write completion is sent to the host computer 10, duplexing is not performed until the duplexing is completed. However, as an SSD used as a storage medium is highly reliable compared with an HDD, and the time while the duplexing is not performed is negligible.

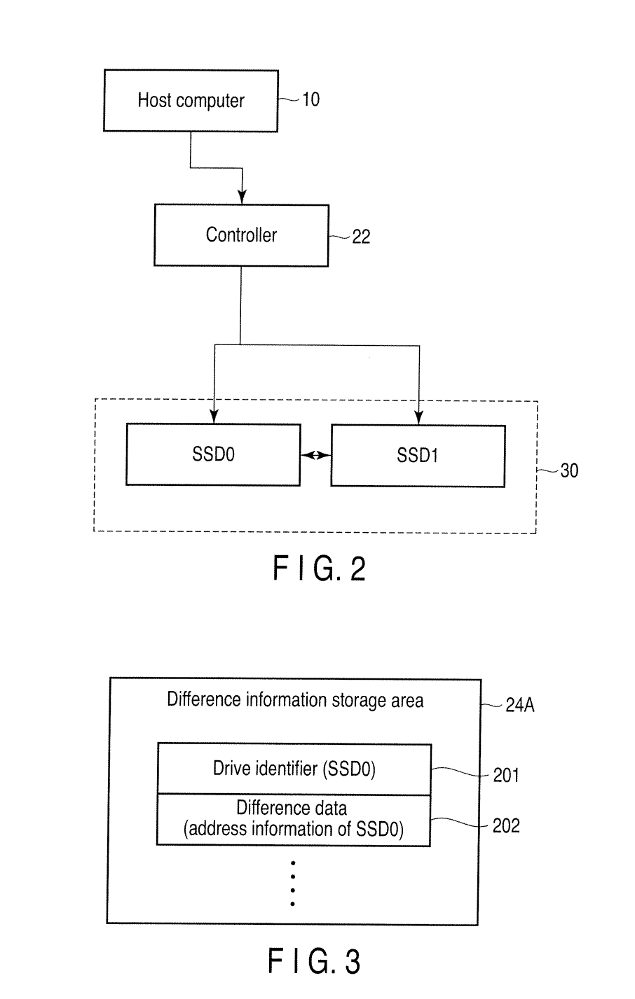

FIG. 3 diagrammatically shows an example of difference information stored in the difference information storage area 24A. The difference information stored in the difference information storage area 24A consists of a drive identifier 201, and difference data 202. The difference information corresponds to data transferred from the host computer 10 and stored in SSD0 of the duplexing data storage 30. The difference information storage area 24A stores difference information consisting of a drive identifier (SSD0) 201 and difference data (address information of SSD0) 202. A drive identifier identifies storage media (SSD, HDD, etc.) incorporated in the duplexing apparatus 20, for example, model names and serial numbers of storage media. If the duplexing apparatus 20 comprises two SSD, two storage media are identified by SSD0 and SSD1. The difference data 202 includes the following information. If the duplexing apparatus 20 comprises two SSD, the data transferred from the host computer 10 is written in one of the SSDs (e.g., SSD0). The difference data 202 is address information of a storage area of SSD0 storing the data in this state. The data stored in the storage area of SSD0 (the data transferred from the host computer 10) is read according to the address information, and transferred to and written in the other SSD (e.g., SSD1), thereby duplexing the data transferred from the host computer 10. Address information may be created by using address of each sector of storage medium, or making a bitmap corresponding to each storage area.

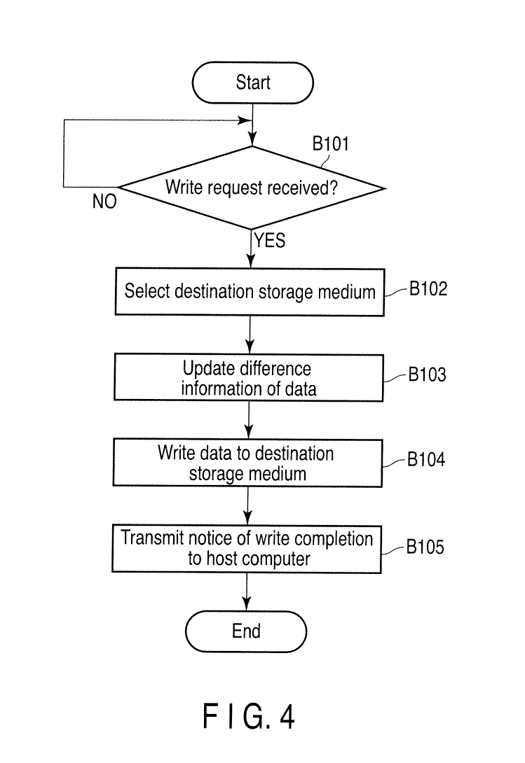

Next, an explanation will be given of a procedure of writing data executed by the duplexing apparatus 20 with reference to the flowchart of FIG. 4.

The controller 22 of the duplexing apparatus 20 determines whether the host computer 10 transfers data to the duplexing apparatus 20, and receives a write request notice (block B101). If the controller 22 determines that the host computer 10 transfers data to the duplexing apparatus 20, and receives a write request (YES in block B101), the controller 22 selects a destination storage medium to write the data transferred from the host computer 10 (block B102). The destination storage medium is selected by the priority information stored in the priority information storage area 24B in the flash memory 24 of the duplexing apparatus 20. For example, if the duplexing apparatus 20 comprises SSD0 and SSD1, and the priority information is SSD0, the controller 22 selects SSD0 as a destination storage medium to write the data transferred from the host computer 10. Then, the controller 22 updates the difference information stored in the difference information storage area 24A in the flash memory 24 of the duplexing apparatus 20 by regarding the data transferred from the host computer as difference information (block B103). The difference information is updated by updating the drive identifier and difference data (address information of a storage medium storing the data) of the storage medium storing the data transferred from the host computer 10, and storing the updated data in the difference information storage area 24A in the flash memory 24 of the duplexing apparatus 20. For example, SSD0 is stored as a drive identifier, and the address information in SSD0, which is a storage medium storing the data, is stored as difference data.

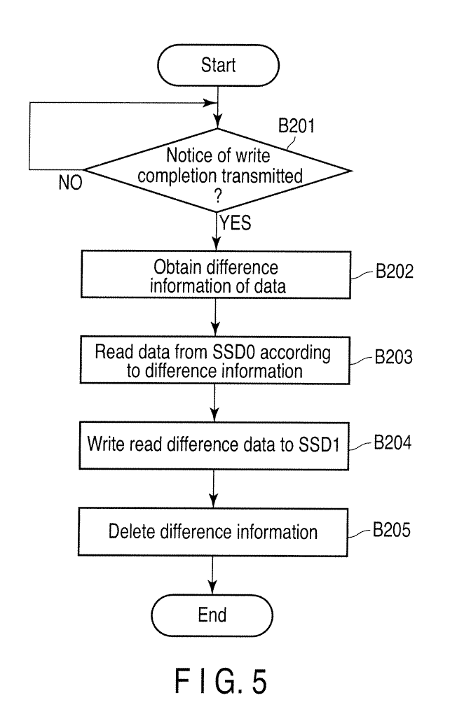

Thereafter, the controller 22 writes the data transferred from the host computer 10 according to the address information of SSD0 (block B104). Updating of the difference information and writing of the data transferred from the host computer 10 may be simultaneously performed, or the data may be previously written. When the controller 22 writes the data transferred from the host computer 10 to SSD0 in block B104, the controller 22 sends a notice of write completion to the host computer 10 (block B105). In the state of block B105, in which the notice of write completion is sent to the host computer 10, the data transferred from the host computer 10 is written to SSD0 only, and the data is not written (duplexed) to SSD1. The data writing procedure is completed by the above blocks. The controller 22 sends a notice of write completion to the host computer 10, and performs duplexing according to the difference information (FIG. 5).

Next, an explanation will be given of a procedure of duplexing data executed by the duplexing apparatus 20 with reference to the flowchart of FIG. 5.

As described above, the controller 22 of the duplexing apparatus 20 completes writing of the data transferred from the host computer 10 to SSD0 (refer to FIG. 4). If the controller 22 determines that the notice of write completion is sent to the host computer 10 (YES in block B201), the controller 22 obtains (reads out) the difference information stored in the difference information storage area 24A in the flash memory 24 of the duplexing apparatus 20 (block B202). The controller 22 reads the data (data transferred from the host computer 10) from SSD0 according to the obtained difference information (block B203). The difference information includes address information of a storage area of SSD0 as described above, and the controller 22 can obtain the address of the storage area of SSD0 storing the data. Then, the controller 22 writes the obtained data to SSD1 (block B204). After writing the data, the controller 22 deletes difference information stored in the difference information storage area 24A in the flash memory 24 of the duplexing apparatus 20, corresponding to the written data (block B205). The data duplexing procedure is completed by the above blocks. The duplexing may be periodically executed at preset time intervals. The duplexing may be executed when a predetermined load is detected by monitoring the processing load of the duplexing apparatus 20. The duplexing may be executed when predetermined amount of difference information is stored. The duplexing is not limited to the above conditions, and may be executed by setting various conditions. The duplexing may be executed when the above two or more conditions are satisfied.

According to the above embodiment, data is written to one of duplexing storage media, a notice of write completion is sent to a host computer when data writing is finished, and duplexing is performed (the data written to one storage medium is written to the other storage medium) after the notice is sent, thereby duplexing can be performed at high speed with small load.

In the difference information storage area 24A, difference information consists of a pair of drive identifier 201 and difference data 202 (refer to FIG. 3). Difference information is not limited to this composition. In the embodiment shown in FIG. 3, the data written to only one storage medium (SSD0) is duplexed in the other storage medium (SSD1). This is applicable to a case where data is written in both SSD0 and SSD1.

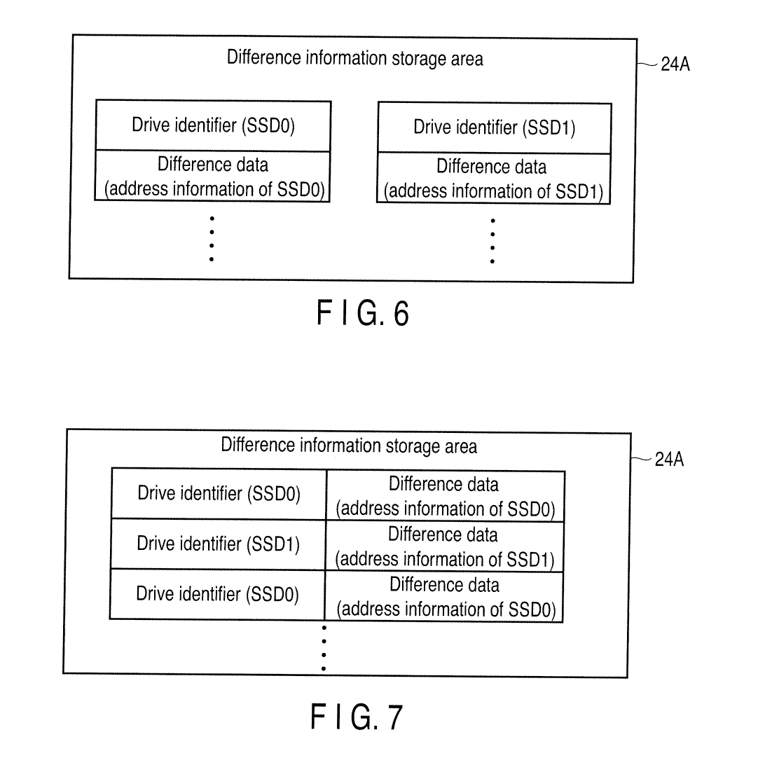

Hereinafter, an explanation will be given of a case where data is written in both SSD0 and SSD1. When data transferred from the host computer 10 is stored in both storage media by switching SSD0 and SSD1, for example, difference information corresponding to both SSD0 and SSD1 is stored in the difference information storage area 24A, as shown in FIG. 6. In this case, the data written to SSD0 is stored in the difference information storage area 24A as a drive identifier (SSD0) and difference data (address information of SSD0), and the data written to SSD1 is stored in the difference information storage area 24A as a drive identifier (SSD1) and difference data (address information of SSD1). The controller 22 sends a notice of write completion to the host computer 10 before duplexing is performed. (Duplexing is actually performed after the notice of write completion is sent.)

The controller 22 reads data from SSD0 and writes the data to SSD1 according to the drive identifier (SSD0) as difference information and difference data (address information of SSD0), and reads data from SSD1 and writes the data to SSD0 according to the disk identifier (SSD1) as difference information and difference data (address information of SSD1), thereby duplexing the data written to both SSD0 and SSD1. Even if the duplexing apparatus 20 comprises three or more storage media, duplexing is possible by increasing the number of difference information and writing data transferred from the host computer 10 to the storage media. Duplexing is possible at high speed regardless of the number of storage media.

In FIG. 6, when the data transferred from the host computer 10 is written to both SSD0 and SSD1, a drive identifier is read as difference information, and address information (difference data) stored in a storage medium corresponding to the drive identify is read (a drive identifier is handled as header information). Difference information may be stored in the difference information storage area 24A as table data, as shown in FIG. 7. In other words, a disk identifier of the storage medium storing the data transferred from the host computer 10 is correlated in parallel with the address information in the storage medium corresponding to the drive identifier, and the correlated information is stored as table data, thereby both drive identifier and address information in the storage medium corresponding to the drive identifier can be read at a time.

Further, in the above embodiment, the duplexing apparatus 20 comprises two storage media. The number of storage media is not limited to two. Duplexing is possible even if one storage media is an SSD, or an HDD is mixed, or all media are HDDs.

As described in the above embodiment, when two or more SSD are used as storage media, as the number of write times (lifetime) is limited in an SSD, the number of write times can be controlled. In other words, when data is written to an SSD, data is written to the block size unit that is a storage cell of the SSD, and the number of unnecessary writing of data smaller than the block size can be reduced. Therefore, by using SSDs with different lifetime, the reliability is increased to higher than the case using SSDs with the same lifetime.

The above description is applicable to a case where duplexing and strapping are simultaneously performed.

Further, in the embodiment described hereinbefore, a destination storage medium of the data transferred from the host computer 10 is selected based on the priority information stored in the priority information storage area 24B in the flash memory 24 of the duplexing apparatus 20. A destination storage medium may be selected in other way. The priority information storage area 24B may not be provided. A destination storage medium may be selected at the time when data is transferred from the host computer 10. When selecting a destination storage medium, the controller 22 can sequentially write data to storage media according to the number of commands waited for processing. A log of history of writing the data transferred from the host computer 10 is recorded, and the data may be written in the order of more or less number of history according to the recorded log. Further, storage medium writing and reading speeds are measured, and the data may be written in the order of the speeds. Storage medium writing and reading speeds are previously measured and stored as priority information in the priority information storage area 24B, and the data may be written according to the priority information.

Further, in the embodiment described hereinbefore, difference information is stored in the flash memory 24 of the duplexing apparatus 20. A storing device is not limited to a flash memory. Difference information may be stored in storage media provided in the duplexing apparatus 20. For example, if the duplexing apparatus 20 comprises SSD0 and SSD1 as storage media, after the data transferred from the host computer is written to SSD0, the difference information corresponding to the data may be written to a preset storage area in SSD1. If the data transferred from the host computer 10 is written to SSD0, the difference information corresponding to the data may be written to a preset storage area in the same SSD0.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A duplexing apparatus comprising:
a controller configured to write data in a first storage module when the data is transferred from a host computer, to read the data from the first storage module when a notice has been transmitted to the host computer, the notice showing that the data is written in the first storage module and a second storage module, and to write the data read from the first storage module in the second storage module; and
a transmission module configured to transmit the notice to the host computer when the data is written in the first storage module.

2. The duplexing apparatus of claim 1, wherein at least one of the first storage module and the second storage module comprises a solid-state drive.

3. The duplexing apparatus of claim 1, wherein the second storage module comprises a solid-state drive,
the controller is configured to write, in the solid-state drive, second data comprising at least a part of the data read from the first module, a size of the second data is equal to a block size of the solid-state drive.

4. The duplexing apparatus of claim 1, further comprising a management information storage module configured to store priority information showing the first storage module,
wherein the controller is configured to write the data in the first storage module based on the priority information when the data is transferred from the host computer.

5. The duplexing apparatus of claim 1, wherein at least one of the first and second storage modules is configured to store priority information showing the first storage module, and
the controller is configured to write the data in the first storage module based on the priority information when the data is transferred from the host computer.

6. A duplexing control method comprising:
writing data in a first storage module when the data is transferred from a host computer;
transmitting, to the host computer, a notice showing that the data is written in the first storage module and a second storage module when the data is written in the first storage module;
reading the data from the first storage module when the notice has been transmitted to the host computer; and
writing, in the second storage module, the data read from the first storage module.

7. The duplexing control method of claim 6, wherein at least one of the first and second storage modules comprises a solid-state drive.

8. The duplexing control method of claim 6, wherein the second storage module comprises a solid-state drive,
the method further comprises writing, in the solid-state drive, second data comprising at least a part of the data read from the first storage module, a size of the second data is equal to a block size of the solid-state drive.

9. The duplexing control method of claim 6, wherein the data is written in the first storage module based on priority information showing the first storage module.
